(19) United States
(12) Patent Application Publication
(10) Pub. No.: US 2025/0252526 A1
(43) Pub. Date: Aug. 7, 2025

(54) METHOD FOR GPU SCHEDULING IN A VIRTUALIZED ENVIRONMENT

(71) Applicant: Arm Limited, Cambridge (GB)

(72) Inventor: Abdellah-Medjadji Kouadri-Mostéfaoui, Manchester (GB)

(21) Appl. No.: 18/969,875

(22) Filed: Dec. 5, 2024

(30) Foreign Application Priority Data
Feb. 5, 2024 (EP) 24305193.5

(51) Int. Cl. G06T 1/20

(52) U.S. Cl. CPC G06T 1/20

(57) ABSTRACT

A method and a system for GPU scheduling in a virtualized environment is provided. The provided method for GPU scheduling can be performed by the GPU scheduler that runs in the CPU or GPU for dynamic time slicing. The method includes tracking at least one parameter occurring with respect to operations of the GPU, receiving an access request from a virtual machine, adjusting a time slice allocated to the virtual machine based on the tracked at least one parameter, and granting access to the virtual machine according to the adjusted time slice. The parameter can include GPU usage data from one or more counters and utilize measurements between messages between a GPU scheduler and the virtual machine to determine the time slice allocated to the virtual machine.

### BACKGROUND

Graphic processing units (GPUs) are a type of parallel processing unit that break up tasks to run in parallel in order to speed up the processing time. Virtualization exposes multiple execution environments, e.g., virtual machines (VMs), on a CPU. Devices such as GPUs can be shared across multiple VMs through a process called time-slicing, where the execution capability of the GPU is re-assigned to each VM in turn. This can be hardware assisted, where a static interface to the GPU is mapped into each VM, and the GPU exposes an interface to change which VM interface is able to access the execution capability of the GPU. This is a type of co-operative virtualization; each VM is requested to yield the GPU to allow re-assignment to another VM. A device like a GPU may require frequent time-slicing to retain good throughput and latency.

Currently in systems where the GPU is scheduled between multiple virtual machines, the software component responsible for the scheduling, e.g., a GPU scheduler, uses fixed values for the time it allocates to each virtual machine. However, this approach is not suited for systems like smartphones where a user can download a random application with an unknown GPU usage pattern and run the application on a virtual machine. In addition, assigning/reassigning the GPU between multiple virtual machines has a non-negligible overhead and over and/or under scheduling can significantly decrease performance.

### BRIEF SUMMARY

A method and a system for GPU scheduling in a virtualized environment are provided. The provided method and system for GPU scheduling can be utilized by the GPU scheduler that runs in the CPU or the GPU for dynamic time slicing. When using dynamic time slicing for a GPU that is scheduled between multiple virtual machines, as described herein, the time allocated for each virtual machine to utilize the GPU better fulfills the amount of time each virtual machine needs to complete its submitted content running on the GPU. By using the proposed methods, the performance, e.g., throughput and/or latency, of the VMs utilizing the GPU can be improved. This approach also works well when the GPU scheduler uses priority-based scheduling.

A method for GPU scheduling in a virtualized environment includes the steps of: tracking at least one parameter with respect to operations of the GPU; receiving an access request from a virtual machine; adjusting a time slice allocated to the virtual machine based on the tracked at least one parameter; and granting access to the virtual machine according to the adjusted time slice.

A system includes a GPU and a GPU scheduler. The GPU scheduler performs the method for GPU scheduling in a virtualized environment described above.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a schematic diagram of a current implementation of a GPU scheduler in communication with a plurality of virtual machines.

FIG. 2 illustrates a sequence diagram for GPU scheduling based on a fixed time slice.

FIG. 3 illustrates an operating environment for dynamic time slicing for virtual machine access.

FIG. 4 illustrates a schematic diagram of an implementation of a GPU scheduler in communication with virtual machines utilizing dynamic time slicing.

FIG. 5 illustrates a sequence diagram for GPU scheduling based on a dynamic time slice.

### DETAILED DESCRIPTION

A method and system for GPU scheduling in a virtualized environment are provided. The provided methods for GPU scheduling can be utilized by the GPU scheduler that runs in the CPU or GPU for dynamic time slicing. When using dynamic time slicing for a GPU that is scheduled between multiple virtual machines, as described herein, the time allocated for each virtual machine to utilize the GPU better fulfills the amount of time each virtual machine needs to complete its submitted content running on the GPU.

A virtual machine virtualizes both the operating system kernel and the application layer. A virtual computing system includes a virtual environment that enables isolated execution of operations and/or processes described herein using computing hardware. A virtual computing system may include a virtual machine, a container, a hybrid environment that includes a virtual machine and a container and/or the like. A virtual computing system may execute one or more applications using a file system that includes binary files, software libraries, and/or other resources required to execute applications on a guest operation system (e.g., within the virtual computing system or the host operating system).

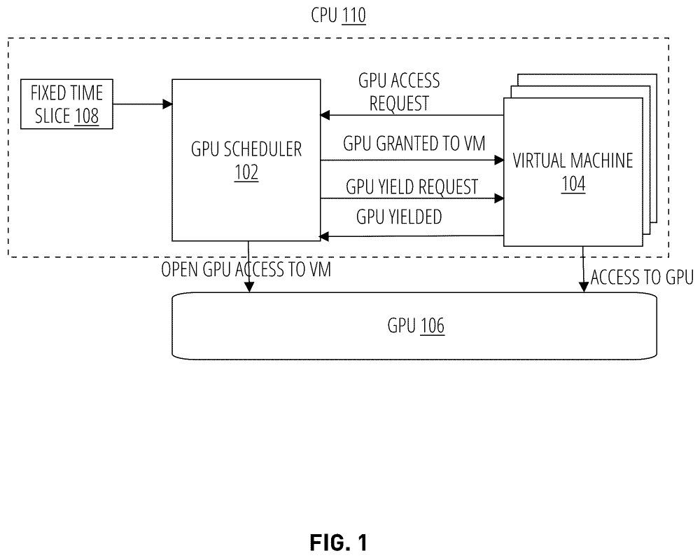

FIG. 1 illustrates a schematic diagram of a current implementation of GPU scheduler in communication with a plurality of virtual machines. The GPU 106 is accessed from a host processor such as CPU 110. For example, an application, such as a game, executing on the CPU 110, will need graphics processing operations to be performed by an associated GPU 106 that executes graphics processing. The GPU scheduler 102 can be a component of CPU (central processing unit) 110, as shown, or it can be a component of the GPU 106. The GPU scheduler 102 prioritizes and queues up the work for the GPU 106, managing when and how the GPU 106 handles tasks. Traditionally, the GPU scheduler 102 utilizes a fixed time slice 108 allocated to each virtual machine 104 of the plurality of virtual machines 104 for access to the GPU 106. The fixed time slice 108, can be the same for each virtual machine, e.g., a single value for all virtual machines, or each virtual machine can have a different (from each of the other VMs), but fixed time slice throughout the processing.

For example, as shown in FIG. 1, virtual machine 104 sends a GPU access request to the GPU scheduler 102 for access to the GPU 106. The GPU scheduler 102 grants access to the virtual machine 104 at which time the GPU scheduler 102 opens GPU access to the virtual machine 104. Virtual machine 104 machine then accesses the GPU 106 to submit its work, e.g., to execute content on the GPU 106. After the fixed time slice 108 is complete, the GPU scheduler 102 sends a message to the virtual machine 104 to yield the GPU. The virtual machine 104 yields the GPU 106 and replies with a GPU Yielded message. Likewise, each VM desiring access to the GPU is granted the fixed time slice 108 for access to the GPU 106. If, however, virtual machine 104 is still submitting work, e.g., has content running, to the GPU 106, at the end of the fixed time slice 108 allocated to virtual machine 104, the content running will still need some additional time before being suspended.

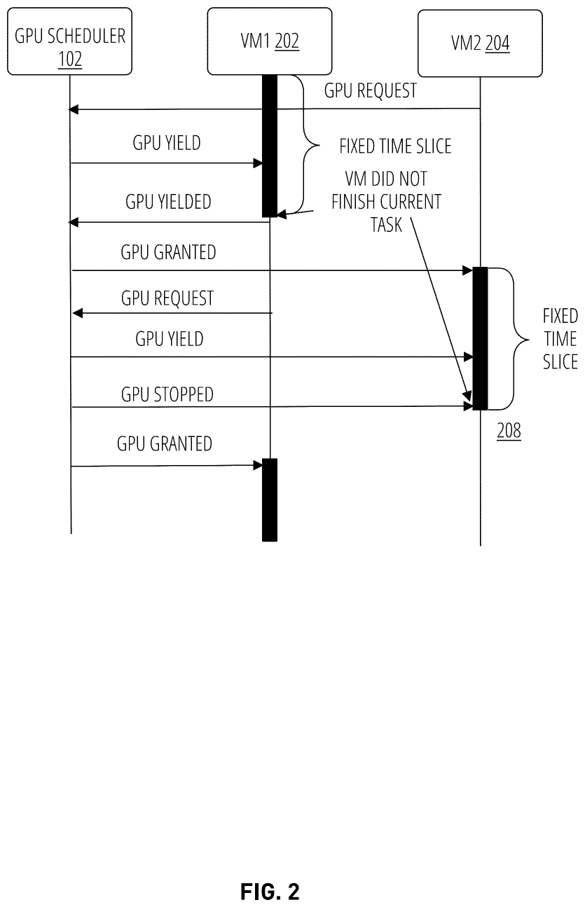

FIG. 2 illustrates a sequence diagram for GPU scheduling based on a fixed time slice as described with respect to FIG. 1. Utilizing fixed time slices allocated to multiple virtual machines sharing access to a GPU, results in non-optimal scheduling points. The scheduling point is the time at which GPU access is removed from one virtual machine and given to another virtual machine.

In FIG. 2, the GPU scheduler 102 provides GPU scheduling for two virtual machines. The use of two virtual machines 104 is provided as a simple example; more than two virtual machines can be scheduled by GPU scheduler 102 for the use of the GPU 106. For example, the number of virtual machines being scheduled to use the GPU 106 can be in a range of 2-64. The range given is for exemplary purposes only, more than 64 can also be scheduled for use of GPU 106 by the GPU scheduler 102. The number of virtual machines scheduled to use the GPU 106 depends on the target system. It becomes increasingly costly for scheduling VMs as the number of VMs increases. Thus, the proposed methods can decrease these scheduling costs by dynamically scheduling virtual machines to use only the time each VM needs.

The sequence diagram details the operational commands and responses between the GPU scheduler 102 and each of a first virtual machine (VM1 202) and a second virtual machine (VM2 204). For example, VM1 202 is utilizing the GPU to execute its content for a fixed time slice 108 (as shown by blackened rectangle) when VM2 204 sends a GPU Request to the GPU scheduler 102. Towards the end of the fixed time slice 108, the GPU scheduler 102 sends a GPU Yield command to VM1 202. VM1 202 returns a GPU Yielded message to the GPU scheduler 102 and stops sending content to the GPU prior to completing its task. Thus, the GPU did not finish executing the content for VM1 202.

The GPU scheduler 102 then grants access to VM2 204 through a GPU Granted message for the fixed time slice 108 (as shown by blackened rectangle). During the fixed time slice 108 with VM2 204 accessing the GPU 106 to execute its content, VM1 202 asks for access to the GPU 106 by a GPU Request message. When the fixed time slice 108 is completed, the GPU scheduler 102 sends the GPU Yield message to the VM2 204. VM2 204 does not yield its time and sends a GPU Yielded message, however, the GPU scheduler 102 sends a GPU Yielded command ending access to the GPU 106 before VM2 204 has finished its current task. GPU scheduler 102 then grants VM1 202 access to the GPU through a GPU 106 Granted message for a fixed time slice 108.

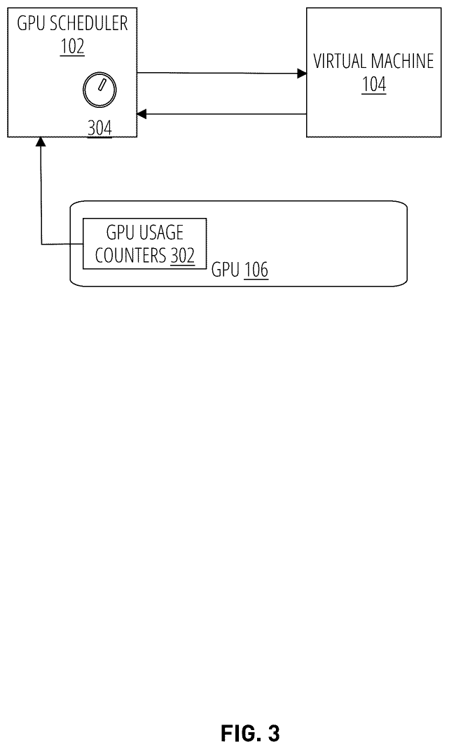

FIG. 3 illustrates an operating environment for dynamic time slicing for virtual machine access. The GPU scheduler 102 continuously adjusts the time slice given to the virtual machine 104 based on at least one tracked parameter occurring with respect to operations of the GPU. The tracked parameter can be GPU usage counters 302 and/or a measured time utilizing a system clock 304. The GPU usage counters 302 are activity counters that measure hardware related activities. In some cases, each GPU usage counter measures the time a corresponding VM uses the GPU. In some cases, the GPU usage counters 302 are those present in the GPU 106 that are already used to calculate the dynamic voltage and frequency scaling which adjust the power and speed settings on the GPU to optimize resource allotment for tasks. In other cases, counters can be used that measure the GPU memory subsystem activity and/or shader core (processing core of the GPU's execution engine) counters. However, any suitable GPU usage counters may be used for dynamic time slicing for the VMs.

The measured time can be the time taken by the virtual machine 104 to yield. For example, referring to FIG. 2, the measured time can be calculated by taking a difference between the time the GPU Yield message was sent to the VM and the time that the virtual machine 104 responds to the GPU with the GPU Yielded message, e.g., the time taken by the VM to yield. For better optimization of the dynamic time slice, multiple samples can be used. Thus, for a period of time, the GPU scheduler 102 measures the time taken for the virtual machine 104, or multiple virtual machines 104, to yield corresponding to multiple accesses to the GPU 106. In some cases, the GPU scheduler 102 computes an average of the measured times taken for the virtual machine 104, or multiple virtual machines 104, to yield. The average of the measured times from the multiple samples can be utilized to adjust the time slice given to the virtual machine 104. In other cases, the minimum or maximum measure time of the multiple samples can be utilized to adjust the time slice given to the virtual machine 104. While the measured time has been described as the time taken by the virtual machine to yield, the measured time can be determined in other ways, such as a measurement between other types of messages, e.g., when the VM becomes IDLE.

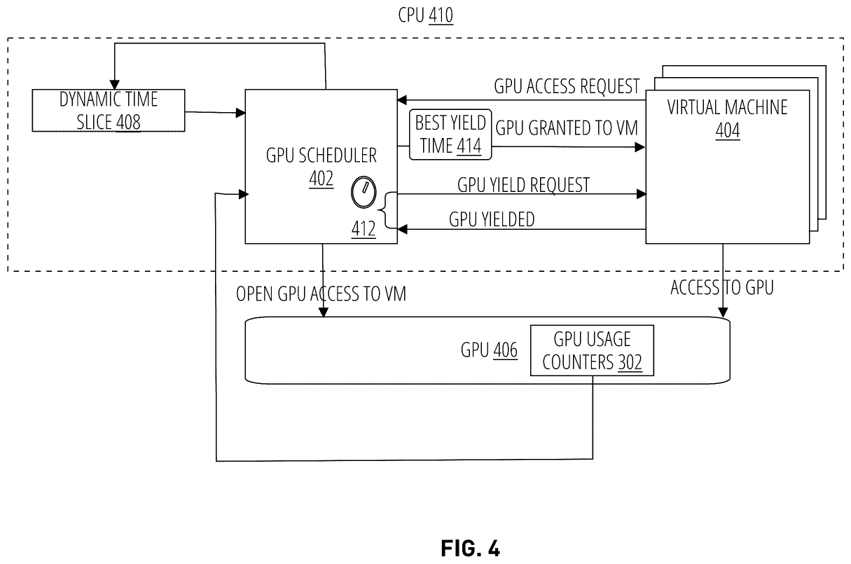

FIG. 4 illustrates a schematic diagram of an implementation of a GPU scheduler in communication with virtual machines utilizing dynamic time slicing. As described with respect to FIG. 1, GPU scheduler 402 is a component of CPU (central processing unit) 410 that prioritizes and queues up the work for the GPU 406, managing when and how the GPU 406 handles tasks. In the shown implementation, the GPU scheduler 402 utilizes a dynamic time slice 408 allocated to each virtual machine 404 of multiple virtual machines 404 for access to the GPU 406. The dynamic time slices 408 are continuously adjusted by the GPU scheduler 402 based on the GPU usage counters 302. In some cases, the dynamic time slices 408 are continuously adjusted based on the GPU usage counters 302 and the time needed by the virtual machine 104 to yield. While usage counter information and measured times have been described herein as metrics used by the GPU scheduler to adjust the dynamic time slices, other metrics computed by the GPU scheduler based on message exchanges with the virtual machines can be used for this purpose as well. System clock 412 can be used to measure the time needed by the virtual machine 104 to yield.

For example, as shown in FIG. 4, virtual machine 404 sends a GPU Access Request message to the GPU scheduler 402 for access to the GPU 406. In contrast to the implementation shown in FIG. 1, the GPU scheduler 402 grants access to the virtual machine 404 via the GPU Granted command for the adjusted dynamic time slice 408 according to a best yield time 414. The best yield time 414 corresponds to the scheduling point when the GPU access is removed from a virtual machine currently utilizing the GPU 406. The GPU scheduler 402 then grants access to the virtual machine 404 according to the adjusted time slice at the scheduling point or after the scheduling point. The GPU scheduler 402 opens GPU access to the virtual machine 404. The virtual machine 104 accesses the GPU 406 to submit its work, e.g., to execute content. The dynamic time slice 408 should then provide enough time to complete executing content for the virtual machine 104 on the GPU 106 prior to the GPU Yield Request command.

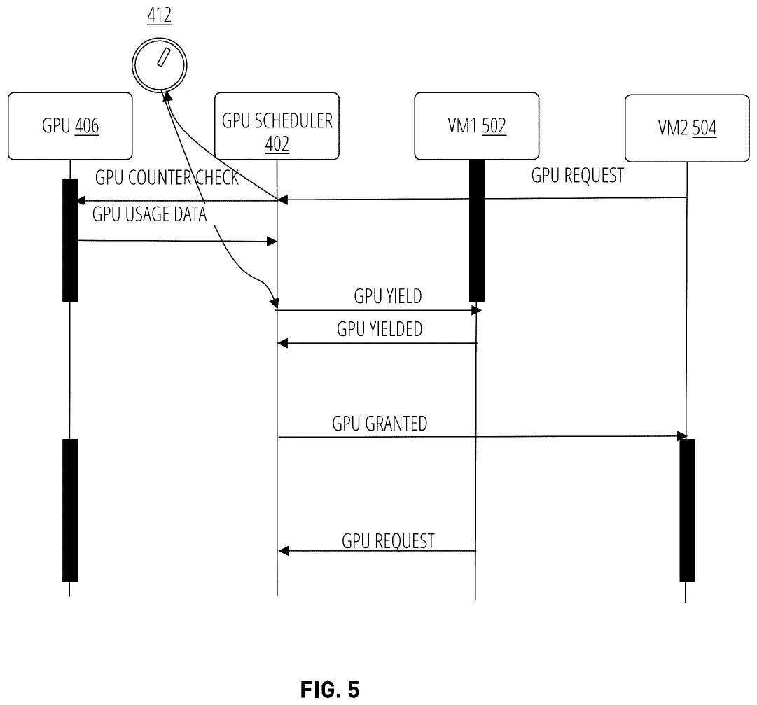

FIG. 5 illustrates a sequence diagram for GPU scheduling based on a dynamic time slice. Similar to FIG. 2, the sequence diagram of FIG. 5 details the operational commands and responses between the GPU scheduler 402 and each of a first virtual machine (VM1 502) and a second virtual machine (VM2 504). For example, the VM1 502 is utilizing the GPU 406 to execute its content for a dynamic time slice 408 (as shown by blackened rectangle) when VM2 504 sends a GPU Request to the GPU scheduler 402. The GPU scheduler 402 retrieves GPU counter data by a direct read of the counter. The GPU scheduler 402 receives the GPU usage data from GPU usage counters 302. The GPU scheduler 402 utilizes the usage counter information and/or a measured time as described previously to compute the scheduling point, e.g., the time the GPU 406 is removed from the VM1 502. VM1 502 finishes executing its content on the GPU 406 before yielding. At the end of the dynamic time slice 408 allocated to VM1 502, the GPU scheduler 402 sends a GPU Yield command. VM1 502 returns a GPU Yielded message to the GPU scheduler 402 and stops sending content to the GPU 406. In this case, an optimal scheduling point was determined and the virtual machine 404 finished the current task before yielding. The GPU scheduler 402 grants access to the GPU 406 to VM2 for the computed dynamic time slice 408. Even though VM1 sends the GPU scheduler 402 a GPU Request message, VM2 504 is able to finish executing its content on the GPU 406 prior to yielding the GPU 406 to VM1 202.

Certain embodiments of the illustrated methods and circuitry include the following.

Clause 1. A method for GPU scheduling in virtualized environment, comprising: tracking at least one parameter occurring with respect to operations of the GPU; receiving an access request from a virtual machine; adjusting a time slice allocated to the virtual machine based on the tracked at least one parameter; and granting access to the virtual machine according to the adjusted time slice.

Clause 2. The method of clause 1, further comprising receiving GPU usage data from one or more counters, and wherein the at least one parameter is based at least in part on the GPU usage data.

Clause 3. The method of clause 1 or 2, further comprising determining a scheduling point for the virtual machine that is currently accessing the GPU to stop based on the at least one parameter.

Clause 4. The method of clause 3, wherein granting access to the virtual machine according to the adjusted time slice is performed at the scheduling point or after the scheduling point.

Clause 5. The method of any of the preceding clauses, further comprising computing a measured time that is a time taken by the virtual machine to yield the GPU, wherein the at least one parameter is based at least in part on the measured time.

Clause 6. The method of clause 5, wherein the measured time is computed by calculating a difference between a first time when a GPU scheduler requests the virtual machine to yield the GPU and a second time when the virtual machine yields the GPU.

Clause 7. The method of clause 5, wherein the measured time is determined based on multiple samples of measured times over a period of time.

Clause 8. The method of clause 7, wherein the measured time is an average of the multiple samples.

Clause 9. The method of clause 7, wherein the measured time is a maximum of the multiple samples.

Clause 10. The method of clause 7, wherein the measured time is a minimum of the multiple samples.

Clause 11. The method of any preceding clause, further comprising receiving GPU usage data from one or more counters; and computing a measured time that is a time taken by the virtual machine to yield the GPU, wherein adjusting the time slice allocated to the virtual machine is based on the GPU usage data received from the one or more counters and the measured time.

Clause 12. A system comprising: a graphics processing unit (GPU); and a GPU scheduler to schedule tasks for the GPU, the GPU scheduler to perform a method of GPU scheduling in a virtualized environment, the method comprising: tracking at least one parameter occurring with respect to operations of the GPU; receiving an access request from a virtual machine; adjusting a time slice allocated to the virtual machine based on the tracked at least one parameter; and granting access to the virtual machine according to the adjusted time slice.

Clause 13. The system of clause 12, further comprising receiving GPU usage data from one or more counters, and wherein the at least one parameter is the GPU usage data.

Clause 14. The system of clauses 12 or 13, further comprising determining a scheduling point for the virtual machine that is currently accessing the GPU to stop based on the at least one parameter.

Clause 15. The system of clause 14, wherein granting access to the virtual machine according to the adjusted time slice is performed at the scheduling point or after the scheduling point.

Clause 16. The system of any of the preceding clauses, further comprising computing a measured time that is a time taken by the virtual machine to yield the GPU, wherein the at least one parameter is the measured time.

Clause 17. The system of clause 16, wherein the measured time is computed by calculating a difference between a first time when a GPU scheduler requests the virtual machine to yield and a second time when the virtual machine yields the GPU.

Clause 18. The system of clause 17, wherein the measured time is determined based on multiple samples of measured times over a period of time.

Clause 19. The system of clause 18, wherein the measured time is an average of the multiple samples.

Although the subject matter has been described in language specific to structural features and/or acts, it is to be understood that the subject matter defined in the appended claims is not necessarily limited to the specific features or acts described above. Rather, the specific features and acts described above are disclosed as examples, implementing the claims and other equivalent features and acts; they are intended to be within the scope of the claims.

What is claimed is:

1. A method for graphics processing unit (GPU) scheduling in a virtualized environment, the method comprising:
tracking at least one parameter occurring with respect to operations of a GPU;
receiving an access request from a virtual machine;
adjusting a time slice allocated to the virtual machine based on the tracked at least one parameter; and
granting access to the virtual machine according to the adjusted time slice.

2. The method of claim 1, further comprising receiving GPU usage data from one or more counters, and wherein the at least one parameter is based at least in part on the GPU usage data.

3. The method of claim 1, further comprising determining a scheduling point for the virtual machine that is currently accessing the GPU to stop based on the at least one parameter.

4. The method of claim 3, wherein granting access to the virtual machine according to the adjusted time slice is performed at the scheduling point or after the scheduling point.

5. The method of claim 1, further comprising computing a measured time that is a time taken by the virtual machine to yield the GPU, wherein the at least one parameter is based at least in part on the measured time.

6. The method of claim 5, wherein the measured time is computed by calculating a difference between a first time when a GPU scheduler requests the virtual machine to yield the GPU and a second time when the virtual machine yields the GPU.

7. The method of claim 5, wherein the measured time is determined based on multiple samples of measured times over a period of time.

8. The method of claim 7, wherein the measured time is an average of the multiple samples.

9. The method of claim 7, wherein the measured time is the maximum of the multiple samples.

10. The method of claim 7, wherein the measured time is the minimum of the multiple samples.

11. The method of claim 1, further comprising:
receiving GPU usage data from one or more counters; and
computing a measured time that is a time taken by the virtual machine to yield the GPU, wherein adjusting the time slice allocated to the virtual machine is based on the GPU usage data received from the one or more counters and the measured time.

12. A system comprising:
a graphics processing unit (GPU); and
a GPU scheduler to schedule tasks for the GPU, the GPU scheduler to perform a method of GPU scheduling in a virtualized environment, the method comprising:
tracking at least one parameter occurring with respect to operations of the GPU;
receiving an access request from a virtual machine;
adjusting a time slice allocated to the virtual machine based on the tracked at least one parameter; and
granting access to the virtual machine according to the adjusted time slice.

13. The system of claim 12, further comprising receiving GPU usage data from one or more counters, and wherein the at least one parameter is the GPU usage data.

14. The system of claim 12, further comprising determining a scheduling point for the virtual machine that is currently accessing the GPU to stop based on the at least one parameter.

15. The system of claim 14, wherein granting access to the virtual machine according to the adjusted time slice is performed at the scheduling point or after the scheduling point.

16. The system of claim 12, further comprising computing a measured time that is a time taken by the virtual machine to yield the GPU, wherein the at least one parameter is the measured time.

17. The system of claim 16, wherein the measured time is computed by calculating a difference between a first time when a GPU scheduler requests the virtual machine to yield and a second time when the virtual machine yields the GPU.

18. The system of claim 17, wherein the measured time is determined based on multiple samples of measured times over a period of time.

19. The system of claim 18, wherein the measured time is an average of the multiple samples.
